(19) United States
(12) Patent Application Publication
(10) Pub. No.: US 2008/0030115 A1
(43) Pub. Date: Feb. 7, 2008

(54) Barrier Discharge Lamp

(76) Inventors: Milhail Erofeev, Tomsk (RU); Mikhail Lomaev, Tomsk (RU); Victor Tarasenko, Tomsk (RU); Victor Skakun, Tomsk (RU); Edward Sosnin, Tomsk (RU); Dmittii Shitz, Tomsk (RU); Thibaut Mercey, Paris (FR); Laurent Meilhac, Chanonat (FR)

Correspondence Address: YOUNG & THOMPSON, 745 SOUTH 23RD STREET, 2ND FLOOR, ARLINGTON, VA, 22202, US

(21) Appl. No.: 11/628,368

(22) PCT Filed: Jun. 2, 2005
(86) PCT No.: PCT/FR05/01361

§ 371 Date: Aug. 23, 2007

(30) Foreign Application Priority Data
Jun. 3, 2004 (FR) 04 06018
Jun. 3, 2004 (FR) 04 06015

(51) Int. Cl. H01J 61/52; H01J 17/28

(52) U.S. Cl. 313/35

(57) ABSTRACT

A barrier discharge lamp wherein an ultraviolet radiation flux is emitted by a working gas confined between two coaxial silica tubes connected at both ends. The gas is subjected to electrical pulses supplied by a generator and applied between an inner and an outer electrode including a conductive window. The cooling is provided by a driven air flow, in particular in the tube, by a fan. Its efficacy is enhanced by a radiator associated with the inner electrode, and by a convective working gas flow. The flow is provided not only around the tube in the vicinity of the electrodes, but in an axial plane with channels on either side of the tube at both ends thereof spaced apart from at least one of the electrodes. The invention is applicable to industrial processes and medical treatments using ultraviolet radiation with very small spectral width, and for treating psoriasis and vitiligo.

A subject of the present invention is a barrier discharge lamp. The principle of such a lamp is described in the document “Discharge Handbook”, Electrogesellschaft, June 1989, 7th edition, page 263. Its radiation is generated by a dielectric working fluid subjected to electrical discharges. Typically, the fluid is a low pressure gaseous medium constituted by a rare gas and/or a halogen. Under the effect of a discharge, it forms excited species of which de-excitation radiative electronic transitions generate a radiation to be emitted. The excited species are typically molecules of the “excimer” or “exciplex” type. The lamp then emits a particularly monochromatic ultraviolet radiation.

The working fluid is confined in a bulb, the walls of which are typically constituted of vitreous silica. The walls form two coaxial tubes constituting an inner tube and an outer tube, and the fluid is confined in the annular space situated between the two tubes.

The electrical discharges are typically caused by steep front high voltage pulses. Typically, the pulses have a maximum voltage of several kilovolts and they last for a few hundred nanoseconds and repeat at a frequency of a few tens or hundreds of kilohertz. They are applied between, on the one hand, an inner electrode located in the inner tube of the bulb and connected, and on the other hand, an outer electrode applied around the outer tube. The walls of the two tubes then constitute two dielectric discharge barriers. Only the inner electrode is brought to a high voltage.

Such an ultraviolet radiation lamp may be used for example in photochemistry or for industrial treatment of surfaces, and also in medicine, especially for dermatological treatments such as those for psoriasis or vitiligo.

The electrical discharges generated in the working fluid may heat the fluid excessively. It is widely recognised that effective cooling of the fluid is an essential condition of the longevity of performance of such a lamp. This was confirmed by the work of the “High Current Electronics Institute” laboratory, the Siberian branch of the Russian Academy of Sciences, to which several of the present inventors belong. The difficulties in obtaining sufficient cooling increase with the power of the lamp and more particularly with the surface power of the radiative flux to be emitted.

A first barrier discharge lamp is known from the patent documents EP0517929 and CA2068574 (Von Arx). In order to ensure the necessary cooling, these documents propose immersing the bulb and the electrodes in a circulating cooling fluid constituted preferably of water. The choice of this fluid permits effective cooling. But it necessitates making troublesome and costly arrangements. It is necessary in particular to maintain the water used at a high degree of purity to ensure correct electrical insulation. With regard to the means necessary for effecting the circulation of the water and maintaining the tightness of the circuits, they are heavy and bulky.

A second barrier discharge lamp is known and is termed “lamp I” in the patent document U.S. Pat. No. 6,379,024 (Kogure). The electrodes of this lamp have limited arc lengths around the axis of the bulb, so that only a part of the working fluid is subjected to the electrical discharges. The necessary cooling is provided by water which circulates in a conduit which extends in the inner tube of the bulb. Such a conduit may make it possible to insulate the water electrically from the inner electrode. But it then has the drawback of limiting the efficacy of the transfer of heat to the water. Moreover, the means for effecting the circulation of the water and maintaining the tightness of the circuits in such a lamp are heavy and bulky. This is perhaps why the document mentions the possibility of using air instead of water. But it is clear that the surface power of the radiative flux emitted by such a lamp would have to be strictly limited if the lamp were to be air-cooled.

A third barrier discharge lamp is known from the patent document US2004004422 (Falkenstein). A heat conduit extends between, on the one hand, a hot part engaged in the inner tube of the bulb of the lamp and, on the other hand, a cold part located and cooled outside that tube. The conduit is a sealed tube in which a liquid evaporates in the hot part, the vapour condenses in the cold part, and the condensed liquid returns to the hot part, for example by capillary action, in order to evaporate there again. It makes it possible to cause a particularly high thermal power to emerge from the inner tube. But it is effective only within a relatively narrow range of temperatures, and its efficacy is then limited by that of the transfer of the heat of the working fluid at its hot part. Moreover, a sufficiently powerful cooling system must be installed at its cold part and be compatible with correct electrical insulation.

The aims of the present invention are in particular to permit:
increasing the surface power of the radiative flux emitted by such a lamp,
limiting the temperature of the working fluid so as to limit the drop in performance of the lamp with the length of service,
limiting the weight, bulk and maintenance cost of the lamp,
rendering the lamp easy to manipulate and, more particularly, portable,
facilitating correct electrical insulation of an inner electrode subjected to high voltage pulses, and
for that purpose, ensuring sufficiently powerful cooling of the working fluid by means of air.

With these aims, its subject is a lamp of the type described above. The lamp includes a radiator arranged with the inner electrode in an inner channel of the bulb of the lamp. The radiator is constituted by a heat-conductive metal and is in at least thermal continuity with the inner electrode so as to transmit heat transversely from that electrode to the cooling fluid. For this purpose, it extends transversely in the channel, remaining spaced from the wall. It extends longitudinally over at least a major fraction of a longitudinal length common to both the electrodes.

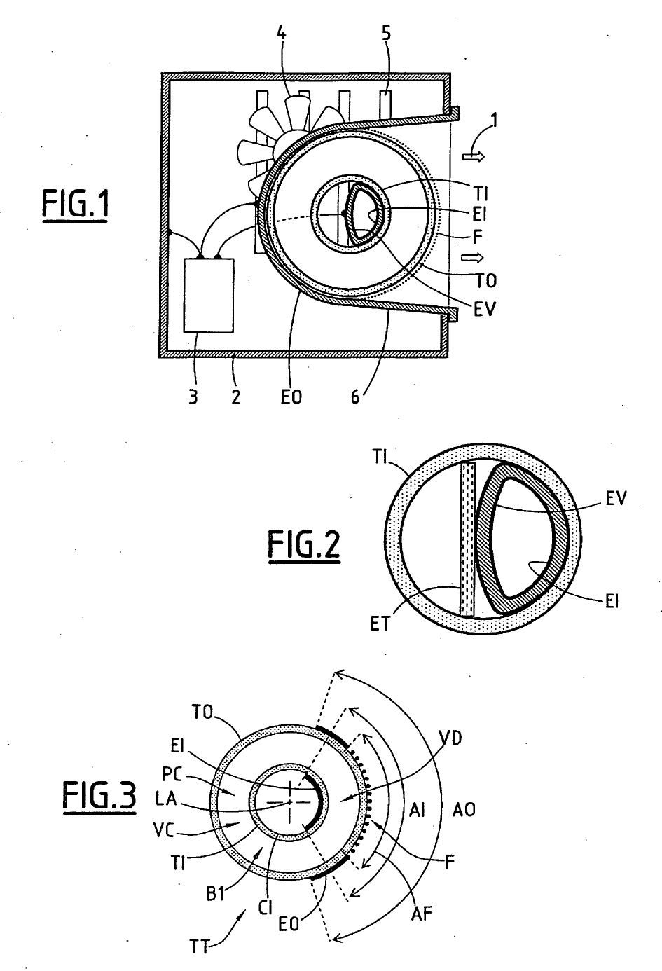

By means of the appended diagrammatic drawings, it will be indicated with the aid of examples how this invention may be implemented. When the same element, or an element performing the same functions, is shown in a plurality of the drawings, it is designated therein by the same reference letters and/or numbers. FIG. 1 shows a view of a first lamp according to the present invention in cross-section with respect to an axis of a bulb of the lamp, a spacer of the bulb not being shown.

FIG. 2 shows a view in cross-section on an enlarged scale of an inner tube of the bulb of FIG. 1.

FIG. 3 shows a cross-sectional view of an inner tube of a bulb of a second lamp according to the invention, with indication of the positions of electrodes of the lamp.

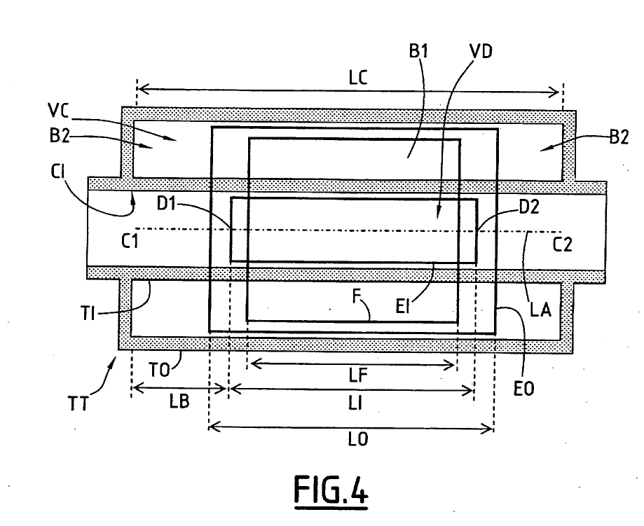

FIG. 4 shows a view in axial section of the bulb of the second lamp according to the invention, with indication of the positions of electrodes of the lamp.

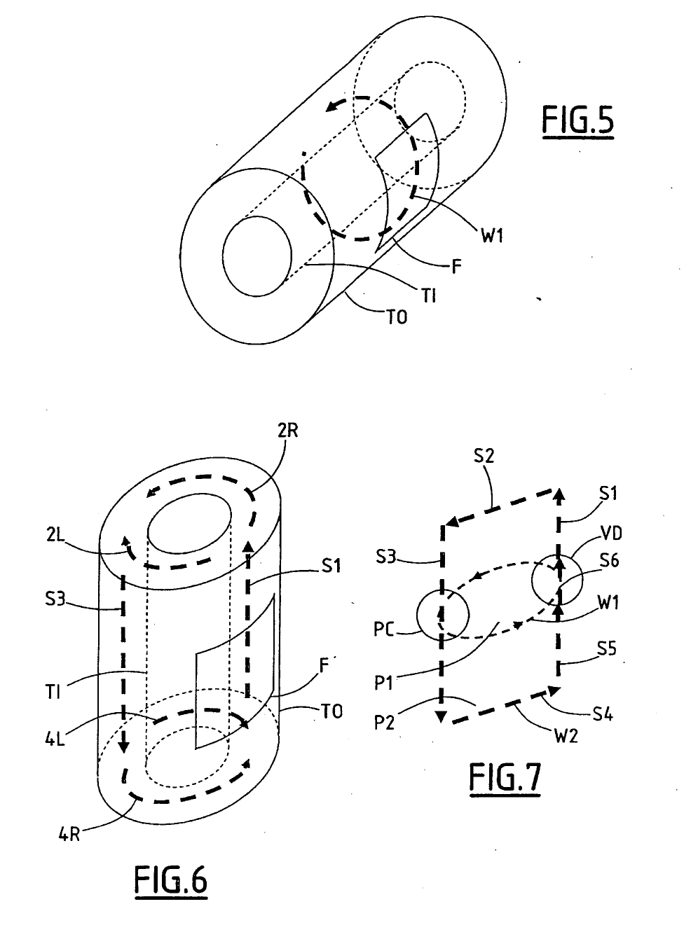

FIG. 5 shows a diagrammatic perspective view of a first convection circuit in a first position of the bulb of FIG. 3.

FIG. 6 shows a diagrammatic perspective view of a second convection circuit in a second position of the bulb of FIG. 3.

FIG. 7 shows a diagrammatic perspective view of the whole of the two convection circuits of FIGS. 5 and 6.

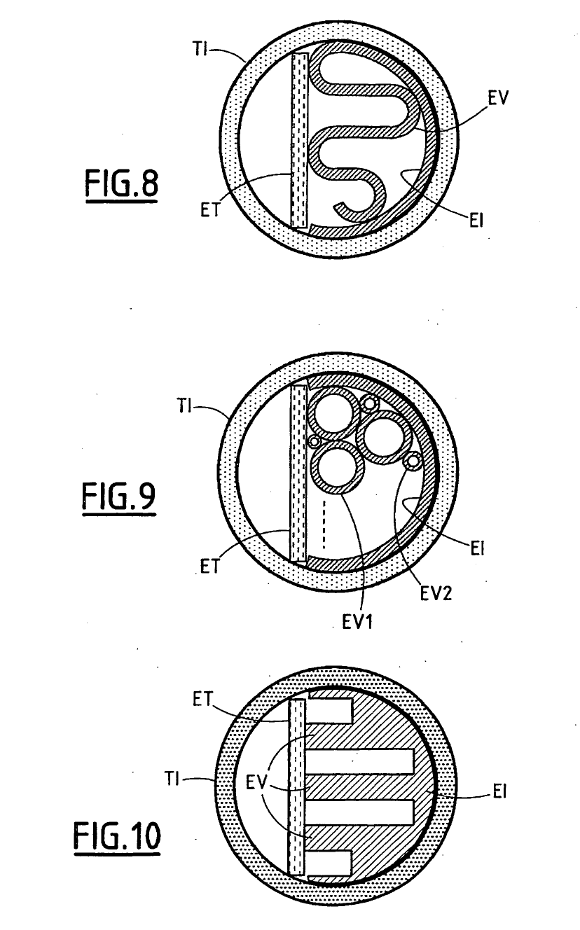

FIG. 8 shows a cross-sectional view on an enlarged scale of an inner tube of the bulb of a third lamp according to the invention.

FIG. 9 shows a cross-sectional view on an enlarged scale of an inner tube of the bulb of a fourth lamp according to the invention.

FIG. 10 shows a cross-sectional view on an enlarged scale of an inner tube of the bulb of a fifth lamp according to the invention.

According to FIG. 1, a barrier discharge lamp emits a flux of ultraviolet radiation represented by two arrows such as the arrow 1.

Typically, it is formed in a housing 2 constituted preferably of metal or of an internally metallised plastics material. The radiation is emitted by a bulb through a window F. The bulb is typically constituted by an inner tube TI and an outer tube TO, coaxial and composed of a vitreous silica such as the quartz sold under the reference GE214 or GE219 by the firm General Electric. Such a bulb is shown at TT in FIGS. 3 and 4. It confines a working fluid in the annular space between the two tubes. The fluid is typically a gas or a gas mixture. The pressures of such gas mixtures range between 0.05 and 1 bar, preferentially between 0.1 and 0.3 bar. For example, in a dermatological application, the gas mixture will be composed of Xe and Cl₂, in the ratio by volume of 250/1, for a total pressure of 114 mm of Hg. The radiation emitted will then have a wavelength of around 308 nm, and will find an application in the treatment of dermatoses such as psoriasis or vitiligo.

An inner electrode EI, shown also in FIG. 2, and an outer electrode EO subject the working fluid to electrical discharges through the walls of the tubes. According to FIG. 1, for this purpose the inner electrode EI receives high voltage pulses which are supplied by a generator 3, the outer electrode EO being connected to the earth constituted by the housing 2. The voltage of the pulses is preferably between 1 and 15 kV, and more preferably between 7 and 11 kV, and their frequency of repetition is preferably between 30 and 150 kHz, and more preferably between 70 and 110 kHz.

The window F is constituted by a part of the outer electrode EO, only that part being transparent, or at least semi-transparent, to the radiation emitted. In the case of the lamp shown in FIG. 1, this electrode surrounds the outer tube TO over 360 degrees. In this case it preferably has two metallic layers, not shown. An inner layer is constituted for example by a sheet of aluminium or an alloy of Al and Mg, 100 μ thick, wound round the tube TO. The sheet has a width equal, for example, to the perimeter of the outer tube plus 1 to 5 mm to allow a slight overlap of the sheet. It has been previously cut out to form the window F. A transparent layer is constituted, for example, by a wire wound in a helix with non-contiguous turns around the inner layer, and clamped onto the inner layer. The wire is, for example, a Nichrome wire of 0.1 mm diameter and is wound with a pitch of approximately 0.7 to 1 mm between each turn. The inner layer and the wire are kept in contact with the tube TO by two circular flanges. The inner layer and the flanges are not shown, and the part of the wire which constitutes the window F is symbolised in FIG. 1 by a dotted line.

The outer electrode may further include a metal sheet EO which is shown in FIG. 1 and which serves to hold the bulb in the housing 2 by means of two extensions such as 6 which join the wall of the housing. The inner surfaces of the two electrodes and of the extensions are treated to reflect the radiation emitted by the bulb so as to reinforce and render uniform the flux emitted by the lamp.

The heat of the electrical discharges is evacuated by means of air which circulates in the tube TI and around the outer electrode EO. The air is driven by one or preferably two fans such as 4, arranged at the two ends of the bulb TT. It enters the housing 2 and leaves it through openings such as 5, formed in the walls of the housing.

FIGS. 3 and 4 show the axis LA of the bulb TT and also the arc lengths AI, AO, and AF and longitudinal lengths LI, LO and LF of the electrodes EI and EO and of the window F, respectively. The dimensions of the bulb and the lengths are selected according to the use envisaged for the lamp. The same applies to the composition and the pressure of the working fluid and the characteristics of the pulses supplied by the generator 3.

The length LC of the space VC inside the bulb TT is preferably between 10 and 2000 mm, and more preferably between 100 and 200 mm. The diameter of the inner tube TI is preferably between 10 and 50 mm, and more preferably around 20 mm. The diameter of the outer tube TO is preferably between 20 and 100 mm, and more preferably around 43 mm. The thickness of the tubes is preferably between 1 and 3 mm, and more preferably around 1.5 mm, and the distance between the outer surface of the inner tube and the inner surface of the outer tube is preferably between 5 and 25 mm, and more preferably around 10 mm.

A lamp according to the invention may have various shapes and arrangements. More generally than above, and within the framework of a first group of advantageous arrangements, it includes essential elements which are shown in the drawings by way of example and which are as follows:

A bulb TT having a wall TI, TO confining the working fluid in a containment space VC. The wall is at least partially dielectric and at least partially transparent to the radiation.

Two electrodes EI and EO arranged outside the bulb and extending opposite one another on either side of a fraction of the containment space. The fraction constitutes a discharge space VD. In the case where only a fraction of the length of one of the two electrodes is opposite the other electrode, the discharge space is limited to that fraction of length. That is to say, the length of the discharge space is constituted by the length common to both the electrodes. Those of the zones of the wall which are located between the two electrodes on either side of the discharge space are dielectric. They constitute, respectively, two discharge barriers.

Means 3 for applying between the two electrodes EI and EO an electrical voltage with alternating variations which is suitable for inducing the necessary electrical discharges in the fraction of the working fluid which is present in the discharge space.

Finally, means 4 for cooling the working fluid through the wall of the bulb.

According to FIGS. 5 to 7 and within the framework of the first group of advantageous arrangements, the wall of the bulb forms for the working fluid at least a first and a second flow path W1 and W2 having a common part constituted by the discharge space. Each of the paths is suitable for channelling a flow of the fluid. For this purpose it passes through a space looping the path and constituting, respectively, a first B1 and a second B2 looping space. It offers to the molecules of the working fluid a multiplicity of possible routes. Of this multiplicity, a mean route defines for the flow of the fluid by that route a mean closed linear circuit. The two such circuits constitute, respectively, a first and a second convection circuit. Since the two paths cannot be represented exactly, they are represented in the form of the circuits W1 and W2. The first and second convection circuits extend respectively in a first and a second looping surface P1 and P2, crossed with one another. These surfaces are typically substantially plane and perpendicular to one another, and the two looping spaces typically have a second common part PC spaced from the discharge space VD.

Each of the two flow paths W1 and W2 has a passage cross-section for the fluid at each point of the convection circuit associated with the path. This cross-section has an area and the whole of the areas of the passage cross-sections of the path includes a minimum area and a mean area. The minimum area is preferably greater than 30% of the mean area.

The lamp is preferably able to be oriented in a plurality of directions so that the flow of the working fluid establishes itself preferentially in one or the other of the two flow paths W1 and W2 according to the direction of orientation of the lamp. The flow is a convection flow. It is brought about by the heating of the fluid in the discharge space VD and by its cooling in the looping space B1 or B2.

Certain of the zones of the wall of the bulb preferably surround the containment space VC and constitute peripheral wall zones TO. Certain others of the zones form an inner channel CI surrounded by the containment space, these other zones constituting internal wall zones TI. The channel has two ends C1 and C2 and an axial line LA extending between these two ends. It has a cross-section at each point of this length and this cross-section has an area and a perimeter. Yet others of these zones of the wall connect the peripheral wall zones to the inner wall zones and constitute connecting wall zones. Lengths LI, LO and LF and two longitudinal directions opposed to each other are defined along the axial line. Two transverse directions opposed to each other VD PC and PC VD are defined with respect to this line. Perimetric lengths AI, AO and AF are defined about this line.

An electrode is arranged in the channel in contact with at least one inner wall zone and constitutes an inner electrode EI. The other electrode extends in contact with at least one peripheral wall zone and constitutes an outer electrode EO.

According to FIG. 3, the discharge space VD has a perimetric length AI substantially less than a complete turn, so that a remaining part of the turn constitutes the first looping space B1 and the first convection circuit W1 extends over the whole of this turn around the inner channel. According to FIG. 5, the circuit is active, that is to say that the first path W1 is the seat of a convective flow, when the axis of the bulb is almost horizontal, on condition, of course, that the window F, beneath which the discharges, and therefore the heating up, are produced, is not pointing upwards. The circuit extends in a vertical plane perpendicular to the axis of the bulb. The flow extends, in only one direction of rotation but at a gradually decreasing speed, to the vicinity of the ends of the tubes TI and TO.

According to FIG. 4, the discharge space has a length LI extending between two longitudinal ends D1 and D2 of this space, and the containment space has a length LC extending between two longitudinal ends C1 and C2 of this space.

Within the framework of the first group of advantageous arrangements, a gap extends between each of the two longitudinal ends of the discharge space and the nearest of the two longitudinal ends of the containment space. The two such gaps constitute a looping gap C1 D1 and a looping gap D2 C2. The second convection circuit W2 then includes, in succession, starting from the discharge space:
a first segment S1 extending in a first longitudinal direction C1 C2 and constituted by a first looping gap,
a second segment S2 constituted by two branches 2R, 2L extending in parallel on either side of the inner channel in, on average, a first transverse direction VD, PC in the length of the first looping gap,
a third segment S3 extending in the second longitudinal direction C2 C1 in a fraction of the containment space transversely opposed to the discharge space, a longitudinal median part of this transversely opposed fraction constituting a part PC common to the first and second looping spaces,
a fourth segment S4 constituted by two branches 4R, 4L extending in parallel on either side of the inner channel in, on average, the second transverse direction PC, VD in the length of a second looping gap, and
a fifth segment S5 extending in the first longitudinal direction and constituted by the second looping gap, and
a sixth segment S6 extending in the first longitudinal direction in the discharge space.

According to FIG. 6, this circuit is active, that is to say that the second path W2 is the seat of a convective flow, when the axis of the bulb is almost vertical, whatever the position of the window F is then.

FIG. 7 shows diagrammatically the relative positions of the circuits W1 and W2 with respect to the bulb. The axis of this latter is assumed to be vertical like the segment S3. That is to say that, with respect to the position of FIG. 5, the bulb is assumed to have tilted through 90 degrees. In the position of FIG. 7, only the circuit W2 is active. It extends in an axial, therefore vertical, plane P2. The circuit W1 is only virtual. Its plane was vertical in FIG. 5, but the tilting of the bulb makes it appear in FIG. 7 as extending in a horizontal plane P1. These two planes cross each other along a virtual straight line passing through a central point of the discharge space VD and through a central point of the common part PC. They are perpendicular to each other.

Each looping gap preferably has a length LB greater than 15% and more preferably greater than 20% of the length LC of the containment space VC.

The axial line LA is preferably rectilinear. It then constitutes an axis of the bulb TT. The peripheral wall zones and inner wall zones respectively constitute an outer tube TO and an inner tube TI. These two tubes are typically transparent and dielectric over the whole of their surface. They are for example cylindrical and coaxial, the perimetric lengths previously mentioned then being arc lengths. They have common longitudinal ends C2 and C1, it being understood that one and/or the other of the tubes may have one or more extensions which have, for example, been useful for the production of the enclosure, but which do not participate in the containment of the working fluid. Such extensions of the tube TI appear in FIG. 4. At least one EI of the electrodes EO and EI terminates longitudinally at distances from these ends to constitute the looping gaps C1 D1 and D2 C2.

The window F is defined by a diaphragm. It is constituted by the opening of the diaphragm. Its longitudinal and angular dimensions are advantageously less than those of the discharge space VD so that only a central, and preferably major, fraction of the flux emitted by the working fluid is transmitted to an external target through the window.

The flux received by this target may then be homogenous, which is useful in numerous applications, whereas it would not be if it was constituted by the whole of the flux emitted by the working fluid.

The outer electrode EO is advantageously present in the emission window F. It is then transparent there, at least partially, to the radiation of the lamp. It is opaque around the window in order to constitute the diaphragm which defines the window. Its longitudinal and arc lengths are then greater than those of the inner electrode EI so that it is the latter which defines the length of the discharge space VD.

The arc length AI of the discharge space VD is preferably between 5 and 180 degrees, and more preferably between 90 and 180 degrees. Its longitudinal length LI is preferably between 60% and 70% of the length LC of the containment space.

The arc length AF and longitudinal length LF of the window F are preferably between 70% and 90%, and more preferably between 80% and 90%, of those AI and LI of the discharge space VD.

The arc length AO and longitudinal length LO of the outer electrode EO are preferably between 110% and 130%, and more preferably between 110% and 120% of those AI and LI of the discharge space VD.

FIGS. 2, 8 and 9 show a second group of advantageous arrangements which find an application in the typical case where the wall TO, TI of the bulb TT forms the inner channel CI and its axial line LA, where one of the two electrodes extends in the channel in contact with at least one inner wall zone and constitutes an inner electrode EI, and where the electrode is constituted by a heat-conductive metal, this wall zone being dielectric. Within the framework of this second group, the lamp further includes a radiator EV extending transversely in the inner channel CI while remaining spaced from the inner wall zones TI. The radiator itself is also constituted by a heat-conductive metal and is in at least thermal continuity with the inner electrode so as to transmit heat transversely from that electrode to the cooling fluid. It extends longitudinally over at least a major fraction, and preferably over at least the whole of a longitudinal length common to both the electrodes. As shown in FIGS. 8 and 9, it has an area of thermal contact with the cooling fluid at least equal to 200% of the area of contact of the inner electrode with the inner wall zones TI.

In the case where in addition the inner electrode EI has in each of the cross-sections of the inner channel CI a perimetric length substantially less than the perimeter of the section, the lamp preferably includes in addition at least one dielectric spacer ET bearing on (resting on) inner wall zones spaced from the inner electrode in order to hold the electrode and/or the radiator EV. The spacer is for example constituted of mica and it has been adhesively secured to the inner tube after the installation of the inner electrode and the radiator.

According to FIG. 2 and 8, the inner electrode EI and the radiator EV are formed by the same metal part. According to FIG. 2, this part is a tube extending longitudinally. The section of the tube includes on the one hand an arc of a circle constituting the electrode EI and on the other hand a straight, convex or concave segment constituting the radiator EV. According to FIG. 8, the metal part EI, EV is a folded sheet with longitudinal fold lines. Folding is carried out in such a way as to form contacts between the folds and the electrode and, optionally, contacts, not shown, between the consecutive folds.

According to FIG. 9, the radiator EV is formed by a plurality of tubes such as EV1 and EV2 which extend longitudinally in transverse contact with one another. The tubes such as EV1 have a larger diameter than the tubes such as EV2. The diameters and the number of these tubes are selected to form a large number of contacts between the tubes, and between the tubes and the electrode EI, and so that the spacer ET provides a permanent bearing force in the majority of the contact zones.

The advantageous arrangements indicated above make it possible to obtain effective air cooling and thus to avoid the heaviness and bulk of water cooling. They make it possible to produce a portable and directable lamp emitting a surface power remaining above 60 mW/cm² for more than 2000 hours.

A practical embodiment of the whole of these advantageous arrangements for the cooling of the lamp is shown in FIG. 10.

The inner electrode EI and the radiator EV are produced in the same metal part, preferably made of aluminium, for example by direct machining of a block of aluminium.

The outer surface of the inner electrode EI has the shape of the inner surface of the inner tube TI with which it is in contact, typically cylindrical and with a diameter of a few tenths of a mm (typically 0.3 mm) less than the diameter of the inner surface of the inner tube TI.

Moreover, this surface of the inner electrode EI has been polished (by manual or electrolytic polishing) and performs the role of reflector for the UV rays emitted towards the centre of the lamp.

The central part of the electrode constitutes the radiator EV, and is constituted by vanes parallel to the flow of cooling fluid and of the same length as the inner electrode EI.

The inner electrode EI is held and locked angularly and axially by a spacer ET of electronically and thermally insulating material (for example a MACOR ceramic).

In another embodiment of the electrode EI, a sheet of aluminium folded and itself also held by a spacer ET as proposed in FIG. 8 may be envisaged. This configuration makes it possible to increase the thermal exchange surface between the inner electrode EI and the cooling fluid. The ratio between this thermal exchange surface and the surface of the inner tube TI opposite the discharge zone is at least greater than two, and preferably greater than four. In addition, the width of the vanes is selected to obtain good conduction of heat from the outer face of the inner electrode EI, heated by the discharges, towards the thermal exchange surfaces.

This configuration also makes it possible to be free of the problems linked to the differential expansion of the inner electrode EI made of metal and the bulb TT made of quartz, since the expansion of the inner electrode EI and its radiator EV occurs to a very great extent between the vanes of the radiator EV, thereby significantly relaxing the mechanical stresses imposed on the inner tube TI of the bulb TT during operation of the lamp.

In order to obtain effective cooling of the lamp, it is also important to facilitate the convection movements of the working gas. For this purpose, the discharge volume VD should represent a minor fraction of the total volume of the working gas, typically between 10 and 50%, and should in no case be in the upper part of this volume so as not to accumulate heat in the top part of the bulb TT.

In a preferred embodiment shown in FIG. 4, the inner electrode EI has a length LI of around 90 mm, which represents approximately 60% of the total length LC of the containment space VC (which is 150 mm in a preferred embodiment of the invention). Similarly, its arc length AI is 240 degrees, which represents a discharge volume VD equivalent to 40% of the total volume of the working gas.

Since the width LF of the window F, in a preferred embodiment of the invention, is 50 mm, and the arc length AF 180°, this configuration ensures a very homogeneous power density at the surface of the window F for emission of the radiation.

For air cooling, in a preferred embodiment of the invention, as the cooling means 4, a fan positioned in the axis LA of the inner tube TI may be used. The fan may be relatively compact, typically 40×40×10 mm³, and with an output of at least 10 m³/hour.

In another preferred embodiment of the invention, a second fan may be added, positioned at the other end of the inner tube TI and the flow of which is emitted in the same direction as the first fan (pull-push configuration).

On the other hand, the discharge volume VD is located in the central zone of the bulb TT so that there is at all times a convection circuit W1 or W2 or a combination of W1 and W2 making it possible to thermalise the working gas whatever the position of the lamp, the only exception being the horizontal position of the axis of the bulb TT with the window F pointing upwards, which must absolutely be avoided, for the reasons given above (convection is then prevented therein).

Hitherto, the existing devices for control concerning the treatment of psoriasis and vitiligo consisted in having a rather large generator 3 and a hand-held portable part separated from its base. These devices have the major drawback of being bulky and relatively expensive to produce.

One of the advantages of our invention is to make the whole system compact.

In a preferred embodiment of the invention, the whole of the system−bulb TT+cooling means 4+generator 3+user interface−stays within a volume of less than two litres (typically 10×10×20 cm³).

The configuration shown in FIG. 10 thus makes it possible to produce an air-cooled portable lamp which can be manipulated in all positions without any particular precaution. To our knowledge, it is the first completely portable dielectric barrier discharge lamp, particularly adapted to dermatological treatments and other uses requiring the lamp to be moved frequently.

1. A barrier discharge lamp, the lamp including:
a working fluid suitable for receiving a succession of electrical discharges and of responding to each of the discharges by emitting a useful radiation while undergoing incidental heating,
a bulb (TT) having a wall (TO, TI) confining said working fluid in a containment space (VC), zones being defined in the wall, at least one of the zones being transparent to said useful radiation, and certain of the zones surrounding the said containment space and constituting peripheral wall zones (TO), certain others of the zones forming an inner channel (CI) surrounded by the containment space, the other zones constituting inner wall zones (TI), the channel having:
two ends (C1, C2),
an axial line (LA) extending between the two ends, lengths (LI, LO, LF) and two longitudinal directions opposed to one another (C1 C2, C2 C1) being defined on the axial line, transverse directions (VD PC, PC VD) being defined with respect to the axial line, and perimetric lengths (AI, AO, AF) being defined about the axial line, and
a cross-section at each point of the length, the cross-section having an area and a perimeter,
the lamp further including:
an electrode extending in the said inner channel in contact with at least one said inner wall zone, the electrode being constituted of a heat-conductive metal and constituting an inner electrode (EI), the inner electrode having a longitudinal length (LI),
an electrode extending outside said bulb in contact with at least one said peripheral wall zone opposite the said inner electrode (EI), the electrode constituting an outer electrode (EO), the outer electrode having a longitudinal length (LO), a longitudinal length (LI) being contained in each of the two said longitudinal lengths of the two electrodes and constituting a longitudinal length common to both the electrodes, the said wall zones extending in contact with an inner wall zone or in contact with an outer wall zone between the inner electrode (EI) and the outer electrode being dielectric in order to constitute, respectively, an inner discharge barrier or an outer discharge barrier,
means (3) for applying between the two said electrodes an electrical voltage with alternating variations suitable for inducing said electrical discharges in the said working fluid between the two electrodes, and
means (4) for circulating a cooling fluid at least in the said inner channel in one of the two said longitudinal directions to evacuate heat transmitted from the said working fluid to the cooling fluid through the said inner discharge barrier and the said inner electrode,
the lamp being characterised in that it further includes a radiator (EV) extending transversely in the said inner channel (CI) while remaining spaced from the said inner wall zones (TI), the radiator being constituted of a heat-conductive metal and being in at least thermal continuity with the said inner electrode (EI) so as to transmit heat transversely from that electrode to the said cooling fluid, the radiator extending longitudinally over at least a major fraction of said longitudinal length common to both the electrodes.

2. A lamp according to claim 1, wherein the said radiator (EV) extends longitudinally over at least a major fraction of the said longitudinal length (LI) of the inner electrode (EI).

3. A lamp according to claim 1, wherein the said radiator (EV) has an area of thermal contact with the said cooling fluid at least equal to 200% of the area of contact of the said inner electrode (EI) with the said inner wall zones (TI).

4. A lamp according to claim 1, wherein the said cooling fluid is air.

5. A lamp according to claim 4, the lamp further including a housing (2) containing at least the said bulb (TT), the two said electrodes (EI, EO), and a fan (4), the fan constituting a said means for circulating the air.

6. A lamp according to claim 1, wherein the said inner electrode (EI) has in each of the said cross-sections of the inner channel (CI) a perimetric length substantially less than the perimeter of the section,
the lamp being characterized in that it further includes at least one dielectric spacer (ET) resting on the said inner wall zones spaced from the said inner electrode in order to hold the electrode and/or the said radiator (EV).

7. A lamp according to claim 1, wherein the said inner electrode (EI) and the said radiator (EV) are formed by the same metal part.

8. A lamp according to claim 7, wherein the said metal part (EI, EV) is a tube extending longitudinally.

9. A lamp according to claim 1, wherein the said metal part (EI, EV) is a folded sheet with longitudinal fold lines.

10. A lamp according to claim 1, wherein the said radiator (EV) is formed by a plurality of tubes (EV1, EV2) extending longitudinally in transverse contact with one another.

11. A lamp according to claim 1, wherein the said axial line is rectilinear and constitutes an axis (LA) of the said bulb (TT), the said peripheral wall zones and inner wall zones constituting, respectively, an outer tube (TO) and an inner tube (TI), the two tubes being transparent, dielectric, cylindrical and coaxial and having common longitudinal ends (C1, C2), the said outer electrode (EO) being transparent at least in an emission window (F).

12. A lamp according to claim 1, wherein a rare gas and/or a halogen constitute to a major extent a said working fluid in which the said electrical discharges can create excimers or exciplexes emitting ultraviolet radiation.

13. A lamp according to claim 11, wherein the wall (TI,TO) is at least partially dielectric and at least partially transparent to the said radiation,
the two electrodes (EI, EO) being opposite each other on either side of a fraction of the said containment space, the fraction constituting a discharge space (VD), those of the said wall zones which are located between the two electrodes on either side of the discharge space being dielectric and constituting, respectively, two discharge barriers,
the electrical voltage with alternating variations being suitable for inducing the said electrical discharges in the fraction of the said working fluid present in the said discharge space, and
characterized in that the said wall of the bulb forms for the said working fluid at least a first (W1) and a second (W2) flow path having a common part constituted by the said discharge space and each being suitable for channelling a flow of the fluid while passing through a space looping the path and constituting, respectively, a first (B1) and a second (B2) looping spaces, each of the paths defining for the flow a closed mean linear circuit associated with the path and constituting, respectively, a first (W1) and a second (W2) convection circuits, the first and second convection circuits extending respectively in a first (P1) and a second (P2) looping surfaces crossed with each other.

14. A lamp according to claim 13, wherein the said first (P1) and second (P2) looping surfaces are substantially plane and perpendicular to each other.

15. A lamp according to claim 13, wherein the said first (B1) and second (B2) looping spaces have a common part (PC) spaced from the said discharge space (VD).

16. A lamp according to claim 13, wherein each of the said first (W1) and second (W2) flow paths has a passage cross-section for the said fluid at each point of the said convection circuit associated with the path, the cross-section having an area, and the whole of the areas of the passage cross-sections of the path including a minimum area and a mean area, the minimum area being greater than 30% of the mean area.

17. A lamp according to claim 16, the lamp being able to be oriented in a plurality of directions so that the said flow of the working fluid establishes itself preferentially in one or the other of the two said flow paths (W1, W2) according to the direction of orientation of the lamp, the flow being a convection flow brought about by the heating up and by the cooling of the fluid respectively in the said discharge space (VD) and in the said looping space (B1, B2).

18. A lamp according to claim 13, wherein certain of the said zones of the wall of the bulb surround the said containment space (VC) and constitute peripheral wall zones (TO), certain others of the zones forming an inner channel (CI) surrounded by the containment space, these other zones constituting inner wall zones (TI), the channel having two ends (C1, C2) and having an axial line (LA) extending between the two ends, lengths (LI, LO, LF) and two longitudinal directions opposed to each other (C1 C2, C2 C1) being defined according to this axial line, two transverse directions opposed to each other (VD PC, PC VD) being defined with respect to the axial line, and perimetric lengths (AI, AO, AF) being defined about the axial line, one said electrode in the channel in contact with at least one said inner wall zone and constituting an inner electrode (EI), the other said electrode extending in contact with at least one said peripheral wall zone and constituting an outer electrode (EO), the said discharge space (VD) having a perimetric length (AI) substantially less than a complete turn, so that a remaining part of the turn constitutes the said first looping space (B1) and the said first convection circuit (W1) extends over the whole of this turn around the said inner channel, the discharge space having a length (LI) extending between two longitudinal ends (D1, D2) of this space, the containment space having a length (LC) extending between two longitudinal ends (C1, C2) of the space, the lamp being characterized in that a gap extends between each of the two said longitudinal ends of the discharge space and the nearest of the two said longitudinal ends of the containment space, the gap constituting a looping gap (C1 D1, D2 C2) such that the said second convection circuit (W2) includes in succession, starting from the discharge space:
a first segment (S1) extending in a first said longitudinal direction (C1 C2) and constituted by a first said looping gap,
a second segment (S2) constituted by two branches (2R, 2L) extending in parallel on either side of the said inner channel in, on average, a first said transverse direction (VD, PC) in the length of the said first looping gap,
a third segment (S3) extending in the second said longitudinal direction (C2 C1) in a fraction of the said containment space transversely opposed to the said discharge space, (a longitudinal median part of this transversely opposed fraction constitutes a part (PC) common to the first and second looping spaces,
a fourth segment (S4) constituted by two branches (4R, 4L) extending in parallel on either side of the said inner channel in, on average, the second said transverse direction (PC, VD) in the length of a second said looping gap, and
a fifth segment (S5) extending in the said first longitudinal direction and constituted by the said second looping gap, and
a sixth segment (S6) extending in the said first longitudinal direction in the said discharge space.

19. A lamp according to claim 18, wherein each said looping gap has a said length (LB) greater than 15% and preferably greater than 20% of the said length (LC) of the containment space (VC).

20. A lamp according to claim 18, wherein the said axial line is rectilinear and constitutes an axis (LA) of the said bulb (TT), the said peripheral wall zones and inner wall zones respectively constituting an outer tube (TO) and an inner tube (TI), these two tubes being transparent, dielectric, cylindrical and coaxial and having common longitudinal ends (C1, C2), the said outer electrode (EO) being transparent at least in the said emission window (F), at least one (EI) of the said electrodes (EO, EI) terminating longitudinally at distances from these ends to constitute the said looping gaps (C1 D1, D2, C2).

21. A lamp according to claim 1, wherein the said radiator (EV) has an area of thermal contact with the said cooling fluid at least equal to 400% of the area of contact of the said inner electrode (EI) with the said inner wall zones (TI).

22. A lamp according to claim 13, wherein the longitudinal and angular dimensions of the emission window (F) are less than the discharge space (VD) so that only a major fraction of the flux emitted by the working fluid is transmitted through the window (F) so that the flux emitted is homogeneous.

23. A method for emission of radiation in a controlled direction (1) of a barrier discharge lamp according to claim 1, the method including the following steps:
preparation of a bulb (TT) having a wall (TI, TO) that is at least partially dielectric and at least partially transparent to a radiation, the wall having zones,
containment of a working fluid in the said bulb,
installation of the said bulb and of electrodes (EI, EO) in a housing (2) with the provision of a window (F) for emission of the said radiation from the bulb to the outside of the housing,
orientation of the said housing in order to orient the said window in a selected emission direction,
localised application of successive electrical discharges to the said working fluid by means of the said electrodes through dielectric zones of the said wall in order to cause emission of the said radiation by the fluid through the said window, the discharges also causing heating up of the fluid, and
cooling of the said working fluid through the said wall during the said application of electrical discharges,
the method being characterized in that the said preparation of a bulb includes the configuration of the said wall to provide for the said working fluid two paths (W1, W2), each suitable for permitting the said heating up and cooling to drive a convection flow of the fluid in the path when the said selected emission direction favours that path, the flow being suitable for substantially facilitating the cooling, two mean linear circuits being defined respectively in the two paths for the flow and extending respectively in two surfaces (P1, P2) crossed with each other.

24. A method according to claim 23, wherein the said cooling of the working fluid is effected by a flow of air.

25. A lamp according to claim 1, wherein the wall (TI,TO) is at least partially dielectric and at least partially transparent to the said radiation,
the two electrodes (EI, EO) being opposite each other on either side of a fraction of the said containment space, the fraction constituting a discharge space (VD), those of the said wall zones which are located between the two electrodes on either side of the discharge space being dielectric and constituting, respectively, two discharge barriers,
the electrical voltage with alternating variations being suitable for inducing the said electrical discharges in the fraction of the said working fluid present in the said discharge space, and
characterized in that the said wall of the bulb forms for the said working fluid at least a first (W1) and a second (W2) flow path having a common part constituted by the said discharge space and each being suitable for channelling a flow of the fluid while passing through a space looping the path and constituting, respectively, a first (B1) and a second (B2) looping spaces, each of the paths defining for the flow a closed mean linear circuit associated with the path and constituting, respectively, a first (W1) and a second (W2) convection circuits, the first and second convection circuits extending respectively in a first (P1) and a second (P2) looping surfaces crossed with each other.
